(19) United States
(12) Patent Application Publication
(10) Pub. No.: US 2022/0408651 A1
(43) Pub. Date: Dec. 29, 2022

(54) LAWN MOWER

(71) Applicant: HONDA MOTOR CO., LTD., Tokyo (JP)

(72) Inventors: Nobuo YAMAZAKI, Saitama (JP); Hajime YOSHIMURA, Saitama (JP); Kenta KOHIGASHI, Saitama (JP); Makoto UCHIMI, Saitama (JP); Ryota HISADA, Tokyo (JP)

(73) Assignee: HONDA MOTOR CO., LTD., Tokyo (JP)

(21) Appl. No.: 17/434,656

(22) PCT Filed: Mar. 28, 2019
(86) PCT No.: PCT/JP2019/013732

§ 371 Date: Mar. 10, 2022

(51) Int. Cl. A01D 75/08; A01D 34/74; A01D 34/81

(52) U.S. Cl. CPC A01D 75/08; A01D 34/74; A01D 34/81; A01D 2101/00

(57) ABSTRACT

A lawn mower (10) includes a rotating shaft (16) that is connected to a lawn mowing motor (17) and extends in a substantially vertical direction; a blade (15) that rotates integrally with the rotating shaft (16); and a housing (18) that rotatably accommodates the blade (15) and has an open bottom. The housing (18) is provided with a grindstone (32) capable of coming into contact with the blade (15) from below the blade (15), and the grindstone (32) is capable of moving between a maintenance position where the grindstone is capable of coining into contact with the blade (15) and a standby position where the grindstone is not capable of coming into contact with the blade (15).

### TECHNICAL FIELD

The present invention relates to a lawn mower.

### BACKGROUND ART

Lawn mowers include a reel type lawn mower that mows lawn between a fixed blade and a spiral reel blade that rotates around a rotating shaft extending in a substantially horizontal direction, and a rotary type lawn mower that mows lawn with a blade that rotates around the rotating shaft extending in a substantially vertical direction.

In the lawn mower, when the sharpness of the reel blade or the blade is lowered, so-called white beard, in which a leaf tip of the lawn is crushed and whitened, occurs, and there is a concern that the appearance of the lawn after lawn mowing deteriorates.

Patent Literature 1 discloses a reel type lawn mower that can polish a reel blade regardless of location by attaching a grindstone instead of a fixed blade.

Patent Literature 2 discloses a charging station for an autonomous traveling electric lawn mower provided with a polishing device for polishing a blade of a rotary type autonomous traveling electric lawn mower.

### RELATED ART LITERATURE

### Patent Literature

Patent Literature 1: JP-A-2001-000025

Patent Literature 2: JP-A-2016-120583

### SUMMARY OF THE INVENTION

### Problem that the Invention is to Solve

However, in Patent Literature 2, the blade can be polished only at the charging station. In addition, when mud or mowed grass adheres to the blade of the lawn mower, the user rubs the blade with a brush to clean the blade, which requires a great deal of labor. Therefore, there is a demand for a rotary type lawn mower that can simply perform maintenance (polishing or cleaning the blade) of the blade regardless of location.

The present invention provides a lawn mower that can perform maintenance of a blade regardless of location, even when the lawn mower is a rotary type.

### Means for Solving the Problem

According to an aspect of the present invention, there is provided a lawn mower including: a rotating shaft that is connected to a power source and extends in a substantially vertical direction; a blade that rotates integrally with the rotating shaft; and a housing that rotatably accommodates the blade and has an open bottom, in which the housing is provided with a maintenance tool capable of coming into contact with the blade from below the blade, and the maintenance tool is capable of moving between a maintenance position where the maintenance tool is capable of coming into contact with the blade and a standby position where the maintenance tool is not capable of coming into contact with the blade.

### Advantages of the invention

According to the present invention, it is possible to perform maintenance of the blade regardless of location, even when the lawn mower is a rotary type.

### BRIEF DESCRIPTION OF DRAWINGS

FIG. 1 is a side view of a lawn mower according to an embodiment of the present invention.

FIG. 2 is a sectional view illustrating a blade lift mechanism mounted on the lawn mower of FIG. 1.

FIG. 3 is a sectional view taken along line A-A of FIG. 2.

FIG. 4A is a side view illustrating a moving structure of a revolving type grindstone.

FIG. 4B is a side view illustrating the moving structure of the slide type grindstone.

FIG. 5A is a plan view illustrating a blade and the grindstone during blade maintenance.

FIG. 5B is a side view illustrating the blade and the grindstone during the blade maintenance.

FIG. 6 is a schematic view illustrating a blade lift mechanism according to a modification example, which is mounted on the lawn mower of FIG. 1.

### MODE FOR CARRYING OUT THE INVENTION

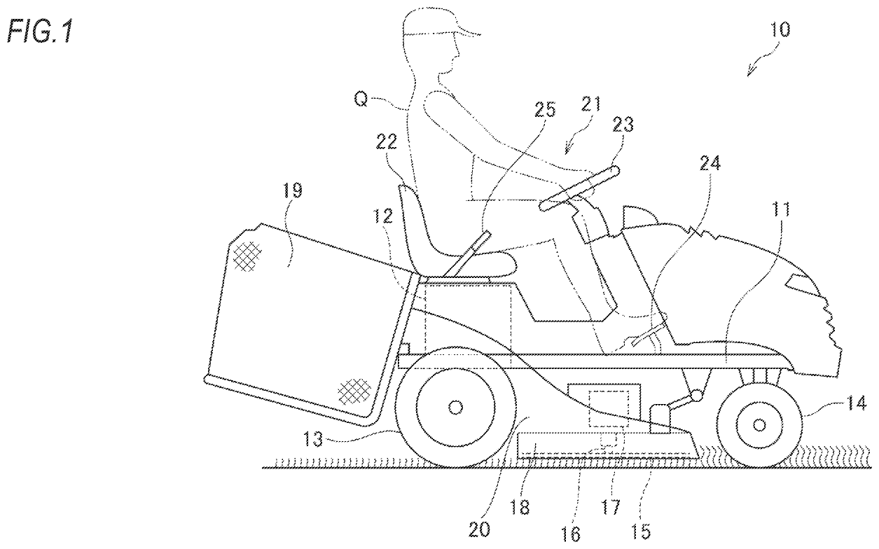

Hereinafter, a lawn mower according to an embodiment of the present invention will be described with reference to FIGS. 1 to 5. in the following description, an advancing direction of a lawn mower 10 is a forward direction, a retracting direction is a rearward direction, and a direction orthogonal to a front-back direction is a left-right direction.

### Lawn Mower

As illustrated in FIG. 1, the lawn mower 10 is a riding type lawn mower and includes an airframe 11. The airframe 11 includes: a traveling motor 12; left and right rear wheels 13 provided at a rear portion of the airframe 11 and driven by the traveling motor 12; left and right front wheels 14 provided at a front portion of the airframe 11; a blade 15 that is provided at a lower portion of the airframe 11 and mows the lawn; a rotating shall 16 that extends in a substantially vertical direction and serves as a rotation center of the blade 15; a lawn mowing motor 17 that rotates the blade 15 via the rotating shaft 16; a housing 18 that covers at least the periphery of the blade 15 and guides the mowed grass backwards; and a grass bag 19 that is disposed behind the housing 18 and stores the mowed grass; a grass duct 20 that guides the mowed grass from the housing 18 to the grass bag 19; and a riding unit 21 on which a worker Q rides.

The riding unit 21 is provided with a seat 22 on which the worker Q sits, a steering handle 23 for steering the front wheels 14, an accelerator pedal 24 for operating an accelerator opening degree, a traveling speed change lever 25 for setting a vehicle speed, and the like.

During the lawn mowing work, the blade 15 is rotated by the lawn mowing motor 17 while making the airframe 11 travel by driving the rear wheel 13 by the traveling motor 12. As the blade 15 rotates, the lawn is mowed, and further, a swirling air flow is created in the housing 18. Accordingly, the grass mowed by the blade 15 rides on the air flow in the housing 18 and is collected in the grass bag 19 through the grass duct 20.

### Blade Lift Mechanism

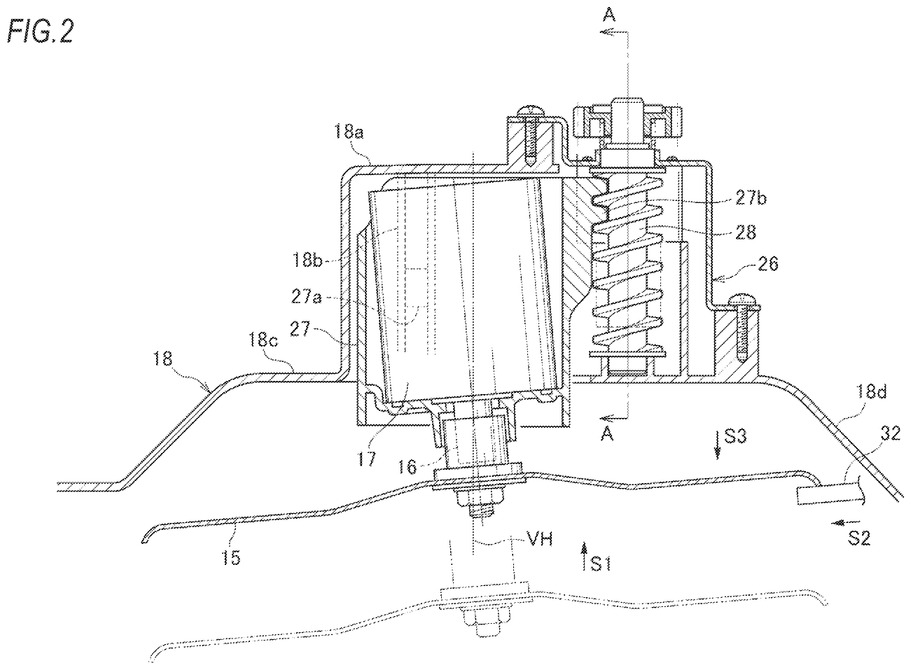

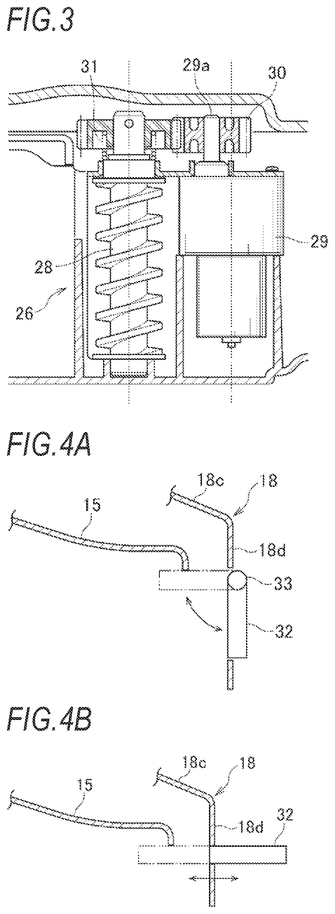

As illustrated in FIGS. 2 and 3, a lift mechanism accommodating unit 18a that accommodates the blade lift mechanism 26 is provided at the upper portion of the center of the housing 18. The blade lift mechanism 26 lifts and lowers the blade 15 to adjust the mowing height of the lawn. The blade lift mechanism 26 of the present embodiment includes: a motor holding member 27 that holds the lawn mowing motor 17 and is supported by the lift mechanism accommodating unit 18a to be capable of being lifted and lowered; a worm gear 28 that extends in a substantially vertical direction while being adjacent to the motor holding member 27, and is rotatably supported by the lift mechanism accommodating unit 18a; a lift motor 29 having a motor shaft 29a that extends in the substantially vertical direction while being adjacent to the worm gear 28; a drive gear 30 provided on the motor shaft 29a; and a driven gear 31 that is provided at the upper end portion of the worm gear 28 and meshes with the drive gear 30.

The lift mechanism accommodating unit 18a includes a guide rail 18b that extends in the substantially vertical direction on an inner wall surface. The motor holding member 27 has a projection portion 27a on an outer wall surface, and the projection portion 27a is slidably engaged with the guide rail 18b so that the motor holding member 27 is supported by the lift mechanism accommodating unit 18a to be capable of being lifted and lowered. Further, the motor holding member 27 has a rack portion 27b that meshes with the worm gear 28 on the outer wall surface.

With the blade lift mechanism 26, when the lift motor 29 is rotationally driven in a counterclockwise direction in a plan view; the worm gear 28 connected via the drive gear 30 and the driven gear 31 rotates in a clockwise direction in a plan view, and transfers the rack portion 27b in a lifting direction. Accordingly, it becomes possible to lift the motor holding member 27, the lawn mowing motor 17, the rotating shaft 16, and the blade 15. Meanwhile, when the lift motor 29 is rotationally driven in the clockwise direction in a plan view, the worm gear 28 connected via the drive gear 30 and the driven gear 31 rotates in the counterclockwise direction in a plan view, and transfers the rack portion 27b in a lowering direction. Accordingly, it becomes possible to lower the motor holding member 27, the lawn mowing motor 17, the rotating shaft 16, and the blade 15.

### Maintenance Tool

The housing 18 is provided with a grindstone 32 that can come into contact with the blade 15 from below the blade 15. The grindstone 32 is provided so as to be movable between a maintenance position where the grindstone 32 can come into contact with the blade 15 and a standby position where the grindstone 32 cannot come into contact with the blade 15. With the lawn mower 10 provided with the grindstone 32, by polishing the blade 15 with the grindstone 32 while rotating the blade 15, it is possible to suppress the occurrence of white beard on the mowed lawn due to the decrease in sharpness of the blade 15. During maintenance work, that is, when the grindstone 32 is at the maintenance position (polishing position), it is preferable to reduce the speed of the blade 15 as compared with a case of mowing work, that is, when the grindstone 32 is at the standby position. For example, the rotation speed of the lawn mowing motor 17 may be changed, or the gear ratio may be switched to decelerate. Further, since the blade 15 can be polished without removing the blade 15 from the lawn mower 10 and without moving the lawn mower 10 to a specific location, the maintenance work can be facilitated. Furthermore, by moving the grindstone 32 between the maintenance position and the standby position, it is possible to avoid interference of the grindstone 32 with the lawn mowing work.

The grindstone 32 may be a revolving type grindstone that moves between the maintenance position and the standby position by revolving as illustrated in FIG. 4A, and may be a slide type grindstone that moves between the maintenance position and the standby position by sliding as illustrated in FIG. 4B.

Specifically, the housing 18 includes a ceiling wall 18c through which the lawn mowing motor 17 or the rotating shaft 16 penetrates, and a peripheral wall 18d that extends downward from the ceiling wall 18c so as to surround the outer periphery of the blade 15. In the present embodiment, the ceiling wall 18c is integrally provided with the lift mechanism accommodating unit 18a, but the ceiling wall 18c and the lift mechanism accommodating unit 18a may be separate bodies.

As illustrated in FIG. 4A, in the revolving type grindstone, for example, one end portion of the grindstone 32 is supported by the peripheral wall 18d to be capable of revolving via a revolving shaft 33. Accordingly, the grindstone 32 can be moved to the maintenance position by revolving toward the inside of the housing 18 with the revolving shaft 33 as a fulcrum. The standby position of the grindstone 32 can be set to any revolving position as long as the standby position is a position that does not protrude toward the inside of the housing 18, but as illustrated in FIG. 4A, a position along the peripheral wall 18d is preferable. In this manner, a space for the grindstone 32 to stand by can be minimized.

In the slide type grindstone, as illustrated in FIG. 4B, for example, the grindstone 32 is slidably supported by the peripheral wall 18d. Accordingly, the grindstone 32 can be moved to the maintenance position by sliding the grindstone 32 toward the inside of the housing 18, and the grindstone can be moved to the standby position by sliding the grindstone 32 toward the outside of the housing 18. The grindstone 32 may be mechanically operable from the outside of the housing 18, or may be electrically operable from the input unit of the riding unit 21.

Since the lawn mower 10 of the present embodiment includes the blade lift mechanism 26 for lifting and lowering the blade 15, the blade 15 can be disposed at an appropriate height when the blade 15 is polished with the grindstone 32. For example, as illustrated in FIG. 2, by performing a step (S1) of lifting the blade 15 to a height that exceeds the maintenance position of the grindstone 32 in a state where the grindstone 32 is made stand by at the standby position, a step (S2) of moving the grindstone 32 from the standby position to the maintenance position, and a step (S3) of lowering the blade 15 to a height by which the blade 15 comes into contact with the grindstone 32, the blade 15 can be disposed at an appropriate height during maintenance.

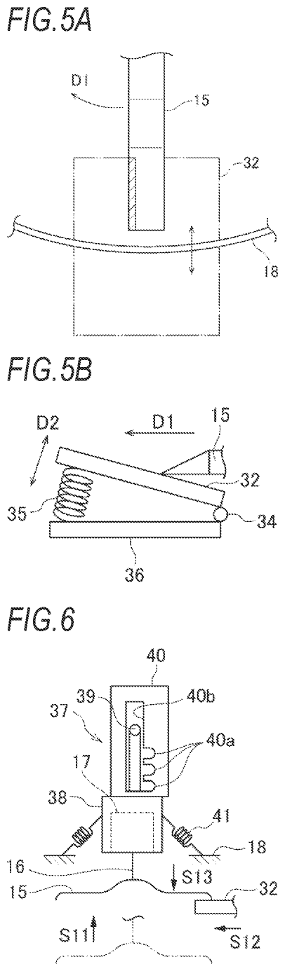

It is desirable that the grindstone 32 comes into contact with the blade 15 diagonally to a rotation direction D1 of the blade 15 as illustrated by an arrow D2 in FIG. 5B. In this manner, the blade 15 can be reliably brought into contact with the grindstone 32, and the edge of the blade 15 can be sharpened effectively.

In a case where a contact surface of the grindstone 32 is disposed diagonally to the rotation direction D1 of the blade 15, the grindstone 32 is supported to be capable of revolving in the up-down direction with an upstream end portion in the blade rotation direction as a fulcrum (revolving shaft 34), and is biased toward the blade 15 by a spring 35. In this manner, when the blade 15 comes into contact with the grindstone 32. the grindstone 32 revolves along the contact surface of the blade 15, and thus, a contact area between the blade 15 and the grindstone 32 increases and the blade 15 can be efficiently polished.

In addition, since a contact pressure of the grindstone 32 with respect to the blade 15 is adjusted by a biasing tierce of the spring 35, deterioration of polishing efficiency due to insufficient contact pressure and the damage of the blade 15 or the grindstone 32 due to excessive contact pressure can be prevented. In FIG. 5B, reference numeral 36 is a grindstone support member that is supported by the housing 18 to be movable between the maintenance position and the standby position and supports the grindstone 32, and the grindstone support member 36 supports the grindstone 32 to be capable of revolving via the revolving shaft 34, and supports the spring 35 made of a compression coil spring between the grindstone 32 and the grindstone support member 36.

### Modification Example

Next, the blade lift mechanism of the modification example will be described with reference to FIG. 6. The same reference numerals will be used for the configurations common to the above-described embodiments, and the detailed description thereof will be omitted.

A blade lift mechanism 37 of the present modification example is different from the above-described blade lift mechanism 26 in that the lawn mowing motor 17 and the blade 15 are manually lifted and lowered. Specifically, the blade lift mechanism 37 includes a motor holding member 38 that holds the lawn mowing motor 17 and is slidably supported in the housing 18 in the up-down direction, a handle 39 that extends upward from the motor holding member 38, and manually lifts and lowers the lawn mowing motor 17 and the blade 15, and a guide member 40 having a locking groove 40a that can lock the handle 39 stepwise at a plurality of heights, and by selecting the locking groove 40a that locks the handle 39, the height of the blade 15, that is, the mowing height of the lawn can be adjusted.

The guide member 40 has a communication groove 40b that makes the plurality of locking grooves 40a communicate with each other along the up-down direction. In a case of changing the height of the blade 15, the handle 39 is locked to a different locking groove 40a via the communication groove 40b. In a state where the handle 39 is positioned in the communication groove 40b, the lawn mowing motor 17 and the blade 15 desire to lower by the own weight. In the present modification example, the communication groove 40b extends upward to widen the lifting range of the lawn mowing motor 17 and the blade 15, and this range is set as the own weight lowering range for blade maintenance.

In other words, as illustrated in FIG. 6, by performing a step (S11) of manually lifting the blade 15 to a height that exceeds the maintenance position of the grindstone 32 in a state where the grindstone 32 is made stand by at the standby position, a step (S12) of moving the grindstone 32 from the standby position to the maintenance position, and a step (S13) of lowering the blade 15 to a height by which the blade 15 comes into contact with the grindstone 32, not only can the blade 15 be disposed at an appropriate height during maintenance, but the blade 15 can be pressed against the grindstone 32 by the own weight (including the weight of the lawn mowing motor 17 and the like). With the blade lift mechanism 37 of the modification example, it becomes possible to omit the mechanism for pressing the blade 15 against the grindstone 32.

During maintenance, in a case where the pressing force is insufficient when pressing with the own weight of the blade 15 or the like, it is preferable to provide a spring 41 for pressing the blade 15 against the grindstone 32. For example, as illustrated in FIG. 6, a plurality of springs 41 made of tension coil springs are provided between the motor holding member 38 and the housing 18. By doing this, the pressure when pressing the blade 15 against the grindstone 32 can be adjusted appropriately.

The above-described embodiment can be appropriately modified, improved, and the like. For example, in the above-described embodiment, a riding type lawn mower is illustrated, but the present invention can also be applied to a walking type lawn mower including a hand-push type and a self-propelled type, and an autonomous traveling type lawn mower. Further, in the above-described embodiment, the motor is exemplified as the power source for rotating the blade, but the power source may be an engine. In addition, in the above-described embodiment, the grindstone is exemplified as a maintenance tool, but the maintenance tool may be a brush for removing mud or mowed grass adhering to the blade.

The present specification describes at least the following contents. In a parenthesis, the corresponding configuration elements and the like in the above-described embodiment are illustrated, but the present invention is not limited thereto.

(1) A lawn mower (lawn mower 10) including: a rotating shaft (rotating shaft 16) that is connected to a power source (lawn mowing motor 17) and extends in a substantially vertical direction; a blade (blade 15) that rotates integrally with the rotating shaft; and a housing (housing 18) that rotatably accommodates the blade and has an open bottom, in which the housing is provided with a maintenance tool (grindstone 32) capable of coming into contact with the blade from below the blade, and the maintenance tool is capable of moving between a maintenance position where the maintenance tool is capable of coming into contact with the blade and a standby position where the maintenance tool is not capable of coming into contact with the blade.

According to (1), it is possible to suppress the occurrence of white beard on the mowed lawn due to the decrease in sharpness of the blade. Further, since it is possible to perform maintenance of the edge of the blade without removing the blade from the lawn mower and without moving the lawn mower to a specific location, the maintenance work can be facilitated. Furthermore, by moving the maintenance tool between the maintenance position and the standby position, it is possible to avoid interference of the maintenance tool with the lawn mowing work.

(2) The lawn mower according to (1), further including: a blade lift mechanism (blade lift mechanisms 26 and 37) that lifts the blade.

According to (2), since the lawn mower includes the blade lift mechanism that lifts the blade, the blade can be disposed at an appropriate height during maintenance.

(3) The lawn mower according to (1) or (2), in which the blade is pressed against the maintenance tool by own weight of the blade when the maintenance tool is at the maintenance position.

According to (3), since the blade is pressed against the maintenance tool by the own weight, the mechanism for pressing the blade against the maintenance tool can be omitted.

(4) The lawn mower according to (3), further including: a first elastic member (spring 41) that presses the blade against the maintenance tool.

According to (4), since the lawn mower includes the first elastic member for pressing the blade against the maintenance tool, the pressure when pressing the blade against the maintenance tool can be adjusted appropriately.

(5) The lawn mower according to any one of (1) to (4), in which the maintenance tool comes into contact with the blade diagonally to a rotation direction of the blade.

According to (5), the edge of the blade can be effectively sharpened as the maintenance tool comes into contact with the blade diagonally to the rotation direction of the blade.

(6) The lawn mower according to any one of (1) to (5), in which the maintenance tool is supported by the housing via a second elastic member (spring 35), and the contact pressure with respect to the blade is adjustable.

According to (6), since the maintenance tool is supported by the housing via the second elastic member, the pressure when the blade is pressed against the maintenance tool can be adjusted appropriately.

(7) The lawn mower according to any one of (1) to (6), in which the housing includes a ceiling wall (ceiling wall 18c) through which the power source or the rotating shaft penetrates, and a peripheral wall (peripheral wall 18d) that extends downward from the ceiling wall so as to surround an outer periphery of the blade, and the maintenance tool is supported by the peripheral wall to be capable of revolving, and is movable between the maintenance position and the standby position by revolving.

According to (7), since the maintenance tool revolves to move between the maintenance position and the standby position, the space where the maintenance tool stands by can be minimized.

(8) The lawn mower according to any one of (1) to (7), in which the maintenance tool is a grindstone, and the maintenance position is a polishing position.

According to (8), by polishing the blade, it is possible to suppress the occurrence of white beard on the mowed lawn due to the decrease in sharpness of the blade.

### DESCRIPTION OF REFERENCE NUMERALS AND CHARACTERS

10 lawn mower

15 blade

16 rotating shaft

17 lawn mowing motor (power source)

18 housing

18c ceiling wall

18d peripheral wall

26 blade lift mechanism

32 grindstone (maintenance tool)

35 spring (second elastic member)

41 spring (first elastic member)

1. A lawn mower comprising:
a rotating shaft that is connected to a power source and extends in a substantially vertical direction;
a blade that rotates integrally with the rotating shaft; and
a housing that rotatably accommodates the blade and has an open bottom, wherein:
the housing is provided with a maintenance tool capable of coming into contact with the blade from below the blade; and
the maintenance tool is capable of moving between a maintenance position where the maintenance tool is capable of coming into contact with the blade and a standby position where the maintenance tool is not capable of coming into contact with the blade.

2. The lawn mower according to claim 1, further comprising
a blade lift mechanism that lifts the blade.

3. The lawn mower according to claim 1, wherein
the blade is pressed against the maintenance tool by own weight of the blade when the maintenance tool is at the maintenance position.

4. The lawn mower according to claim 3, further comprising
a first elastic member that presses the blade against the maintenance tool.

5. The lawn mower according to claim 1, wherein
the maintenance tool comes into contact with the blade diagonally to a rotation direction of the blade.

6. The lawn mower according to claim 1, wherein
the maintenance tool is supported by the housing via a second elastic member, and the contact pressure with respect to the blade is adjustable.

7. The lawn mower according to claim 1, wherein:
the housing includes:
a ceiling wall through which the power source or the rotating shaft penetrates; and
a peripheral wall that extends downward from the ceiling wall so as to surround an outer periphery of the blade; and
the maintenance tool is supported by the peripheral wall to be capable of revolving, and is movable between the maintenance position and the standby position by revolving.

8. The lawn mower according to claim 1, wherein
the maintenance tool is a grindstone, and the maintenance position is a polishing position.
